(19) United States
(12) Patent Application Publication
(10) Pub. No.: US 2019/0277562 A1
(43) Pub. Date: Sep. 12, 2019

(54) Method and Device for Removing Helium from a Pressurized Container

(71) Applicant: Linde Aktiengesellschaft, Munich (DE)

(72) Inventors: Alexander Alexseev, Wolfratshausen (DE); Siegfried Ebner, Pfaffenhofen (DE)

(73) Assignee: Linde Aktiengesellschaft, Munich (DE)

(21) Appl. No.: 16/302,188

(22) PCT Filed: May 18, 2017
(86) PCT No.: PCT/EP2017/061946

§ 371 Date: Nov. 16, 2018

(30) Foreign Application Priority Data
May 18, 2016 (DE) 10 2016 006 142.1

(51) Int. Cl. F25J 1/00; F25D 3/10; F17C 7/02

(52) U.S. Cl. CPC F25J 1/0007; F25D 3/105; F17C 7/02; F17C 2221/017; F17C 2270/0509; F17C 2225/0161; F17C 2227/036; F17C 2227/039; F17C 2270/0171; F17C 2223/0115

(57) ABSTRACT

The present invention relates to a method for removing helium from a pressurized container, wherein supercritical helium is removed from the pressurized container; wherein the removed supercritical helium is actively cooled by means of a cooling device and/or passively cooled by means of a Joule-Thomson expansion; and thereby at least partially forms liquid helium.

### TECHNICAL FIELD

The invention relates to a method for removing helium from a pressurized container as well as to a removal device wherein supercritical helium is removed from the pressurized container.

### SUMMARY OF INVENTION

### Technical Problem

Liquid helium can be stored and transported in pressurized containers at high pressure. During the storage in the container, the aggregate state of the helium can change, and gaseous and/or supercritical helium can form.

If liquid helium is to be removed from the pressurized container with supercritical helium, usually the pressure first of all needs to be released from the container, until the pressure in the container has reached a value of between 210 mbarg and 350 mbarg, or between 3 psig and 5 psig, for example. This pressure release can be achieved in that gaseous or supercritical helium is removed from the pressurized container. In order to lower the pressure by 1 psi in the container, between 80 m³ and 120 m³ of gaseous/supercritical helium has to be removed.

If the pressure has been lowered to an appropriate extent, two phases of helium, a liquid phase and a gaseous phase, form in the pressurized container. It is only after that that, conventionally, the removal of liquid helium is started. The higher the pressure in the container is, the more gaseous/supercritical helium has to be removed, and the less liquid helium can be removed. Depending on the original pressure after the loading of the container, and depending on the storage time of the helium in the container, the yield of liquid helium can thus vary.

### Solution to Problem

It is the aim of this invention to increase the yield of liquid helium during the removal from a pressurized container.

According to the invention there is provided a method and a removal device for removing helium from a pressurized container having the features of the independent. Advantageous designs are the subject matter of the dependent claims and of the subsequent description. Advantages and preferred designs of the method according to the invention and of the removal device according to the invention result similarly from the following description.

According to a first aspect of the invention, there is provided a method for removing helium from a pressurized container wherein supercritical helium is removed from the pressurized container, wherein the method includes: the removed supercritical helium is actively cooled by means of a cooling device and/or passively cooled by means of a Joule-Thomson expansion (220); and thereby at least partially forms liquid helium.

In other words, the method includes removing supercritical helium from the pressurized container; cooling the removed supercritical helium, to produce at least forming liquid helium by actively cooling in a cooling device and/or passively cooling by means of a Joule Thomson expansion.

The helium in the pressurized container is advantageously at a high pressure. In particular, the pressure in the pressurized container is beyond the critical point of helium, so that the helium in the pressurized container is in a supercritical state and thus only in the supercritical phase. At high pressure, in this context, is understood to mean, in particular, pressures greater than 2.28 bara or 33 psia, beyond which helium is only in supercritical state.

In the context of the method, supercritical, in particular cryogenic, helium is first of all removed from the pressurized container. For this purpose, the removal device comprises a connection which is arranged so as to be connected to a removal connection or to a removal valve of the pressurized container, in particular to a fluid removal connection or a fluid removal valve. The supercritical helium that has been removed, which, in particular, is still at high pressure, is cooled actively and/or passively in the context of the invention.

The active cooling may be carried out by means of an active cooling device. In this context, active cooling is understood to mean, in particular, that active energy is used in order to draw energy from the removed supercritical helium and to cool it. Advantageously, during the course of the active cooling, a thermodynamic cycle is implemented. For this purpose, the removal device comprises an active cooling device downstream of the connection.

The passive cooling may be carried out by means of a Joule-Thomson expansion. In the context of such passive cooling, for the cooling of the helium, in particular, no energy needs to be used actively. In the context of the Joule-Thomson expansion, the pressurized helium removed is expanded, preferably, by being supplied to a throttle valve. According to the Joule-Thomson effect, the expanding helium undergoes a cooling in the process. For this purpose, the removal device comprises a Joule-Thomson cooler downstream of the connection, which is advantageously connected downstream of the active cooling device.

Due to the active and/or passive cooling, at least a portion of the supercritical helium removed is liquefied.

Conventional helium removal methods are known, during the course of which supercritical helium which is removed for pressure removal is generally supplied to a compressor via an evaporator, and is used for pressurized gas filling.

In contrast, in the present invention the removed supercritical helium is at least partially liquefied, as a result of which the quantity of liquid helium removed from the pressurized container can be increased. Particularly advantageously, the helium removed is cooled both actively and also passively, as a result of which the yield of liquid helium can be further increased.

The method is carried out, preferably, at the beginning of the process of removing liquid helium from the pressurized container, when the helium is preferably exclusively in the supercritical state in the pressurized container. In particular, the method may be carried out after the pressure in the container has been lowered by the removal of the supercritical helium to a predetermined value. The method may be carried out when the pressure has been lowered to 2.28 bara or 33 psia, i.e. starting at which value the helium is in liquid and gaseous phase in the pressurized container, which means that one can begin the direct removal of liquid helium.

Alternatively, or additionally, the method can be carried out at the end of the process of removing liquid helium from the pressurized container. In particular, at the end of the process, a remainder of liquid helium can still be located at the bottom of the pressurized container. The remaining amount cannot generally be removed by means of conventional lines within the pressurized container, since these lies normally do not reach down directly to the bottom. In this case, the pressure in the pressurized container can be increased again, until the remainder of liquid helium transitions into the supercritical phase. The supercritical helium generated in this manner can be removed, cooled actively and/or passively, thereby being at least partially liquefied.

According to a particularly advantageous design, the supercritical helium removed from the pressurized container can be cooled actively by means of a heat exchanger as the cooling device. By means of such a heat exchanger, thermal energy, in particular, is transferred from the removed helium to a medium or cooling fluid. The heat exchanger represents an easy and cost effective possibility for actively cooling the removed helium and it can be integrated in the removal device simply and operated in an uncomplicated manner.

For example, the removed supercritical helium can be led from the connection of the removal device through a line. A cooling fluid can be led around this line, for example, in order to cool the helium. For this purpose, a corresponding cooling fluid line can be arranged around the line of the removal device. The heat exchanger can be integrated advantageously in this manner in the line of the removal device. It is also possible to connect the heat exchanger to an end of the line and thus to connect said heat exchanger after and downstream of the line.

Alternatively, or additionally, the supercritical helium removed from the pressurized container can advantageously be cooled by means of a cooling machine. Cooling machines usually comprise a compressor for the repeated compression and expansion of the helium, and a cooling part, often referred to as cold head, in which the generation of cold itself occurs. Preferably, the cooling machine is preferably designed as one of the following: a Stirling refrigerator; a Gifford-McMahon refrigerator and a pulse tube refrigerator. Although a single type cooling machine is envisaged, the skilled person will appreciate that the term “cooling machine” can be interpreted to include combinations of two or more of the types of refrigerators listed above. Although such cooling machines are more cost intensive than a heat exchanger, the helium removed can be cooled even more effectively and the yield of liquid helium can, in particular, be increased further.

A Stirling refrigerator is used, in particular, for implementation of a Stirling cycle. For example, such a Stirling refrigerator can comprise a piston in a compression cylinder, with downstream thereof a first heat exchanger, a regenerator and an additional heat exchanger, which in turn are followed downstream by an expansion cylinder with an additional piston. By movement of the pistons, the helium is alternatively expanded and compressed, and it is led through the system consisting of heat exchangers and regenerator.

In a Stirling refrigerator, a compressor can be connected as a rule directly to the work volume (so-called integrated design). However, there is also the so-called split design (so-called split Stirling cooling machine), in which two units (compressor and cold head) are connected via a tube.

On the other hand, for Gifford-McMahon refrigerators, it is conventional to use the split design exclusively. Cold head and compressor are thus formed in a Gifford-McMahon refrigerator as separate units connected via two lines. In such a Gifford-McMahon refrigerator, a regenerator and a displacer are arranged in the cold head, which is connected alternately to a high-pressure side to a low-pressure side of a compressor via a distributor valve.

In contrast to a Stirling refrigerator and a Gifford-McMahon refrigerator, in a pulse tube refrigerator (which may also be referred to as a pulse tube refrigerator of the Stirling type), no moveable components in the cold head or in the area of the cold heat-exchange point are used. A pulse tube refrigerator comprises, in particular, a compressor, a first heat exchanger which is followed downstream by a regenerator and an additional heat exchanger. The second heat exchanger is followed by the so-called pulse tube, to which a third heat exchanger is connected. The heat exchangers, the regenerator and the pulse tube are arranged, in particular, in a common cylinder. Said cylinder can be followed downstream by a flow resistor, for example, an aperture, as well as a buffer volume.

In addition to such a pulse tube refrigerator of the Stirling type (as described above), it is also conceivable to connect the regenerator alternately via a distributor valve to the high-pressure and to the low-pressure side of the compressor, and this is referred to as a pulse tube refrigerator of the Gifford-McMahon type.

Advantageously, the Joule-Thomson expansion of the removed helium also generates cold gaseous helium (so-called flash gas), in addition to the liquefied helium. This generated cold gaseous helium is preferably removed. For this purpose, the removal device preferably comprises a gas discharge. Thus, in particular, a pressure ratio between high-pressure side and low-pressure side of the Joule-Thomson cooler can be regulated, as a result of which it is ensured that the Joule-Thomson expansion can continue to be carried out efficiently. The cold gaseous helium is removed, in particular, on the low-pressure side of the Joule-Thomson cooler immediately after the generation thereof.

Advantageously, the cold gaseous helium can here be led along the high-pressure side of the Joule-Thomson cooler. Preferably, the removed cold gaseous helium is thus used in order to cool or precool the supercritical helium removed from the pressurized container, on the high-pressure side before the Joule-Thomson expansion.

Alternatively, or additionally, the cold gaseous helium can preferably be led through the heat exchanger, in counter-current with respect to the removed supercritical helium, thereby cooling said supercritical helium.

The method is preferably suitable for a transferring of the liquid helium from the pressurized container to an additional second pressurized container (container to container), for example, in order to prevent excessive pressure build-up in the pressurized container in the case of long-term storage of the cryogenic helium.

The method is also suitable for transferring the liquid helium from the pressurized container into a Dewar container (container to Dewar). Advantageously, the liquefied helium generated may be supplied to an additional pressurized container or a Dewar container.

According to a further aspect, the invention provides a removal device for removing helium from a pressurized container, comprising:

a first connection, which is arranged to be connected to a removal connection of the pressurized container for the removal of supercritical helium from the pressurized container,

characterized in that the removal device comprises:

an active cooling device downstream of the connection and/or a Joule-Thomson cooler downstream of the connection.

The cooling device may be one of the following: a heat exchanger; a Stirling refrigerator; a Gifford-McMahon refrigerator; or a pulse tube refrigerator.

The removal device may further comprise a gas discharge for removing cold gaseous helium from a low-pressure side of the Joule-Thomson cooler.

The removal device may be further configured such that the cold gaseous helium is conveyed for further cooling purposes and/or other usage, for example helium recovery or gaseous helium filling.

The first connection may be connected to a line. The active cooling device may be integrated in the line and/or connected to said line at the end the line.

The removal device may further comprise a second connection downstream of the cooling device and/or the Joule-Thomson cooler. The second device may be configured to be connected to a second pressurized container and/or a supply line.

For supplying to an additional pressurized container or a Dewar container, the removal device preferably comprises a second connection, which is arranged so as to be connected to a second container, preferably a second pressurized container or a Dewar container. The liquefied helium generated may be is used to cool down a cryostat and/or devices within a cryostat.

Preferably, the connection of the removal device is connected to a line. The active cooling device is preferably integrated in the line. Alternatively or additionally, the active cooling device can also be connected at an end of the line to said line. In particular, the removal device can be implemented as a structural unit which is connected, in particular by means of the two connections thereof, to the pressurized container and thus to the second container.

Additional advantages and designs of the invention result from the description and the appended drawing.

It is understood that the above-mentioned features and the features to be explained below can be used not only in the respective indicated combination, but also in other combinations or individually, without exceeding the scope of the present invention.

The invention is represented diagrammatically in reference to exemplary embodiments in the drawing and described below in detail in reference to the drawing.

### BRIEF DESCRIPTION OF DRAWINGS

FIG. 1 is a diagram showing a preferred design of a removal device according to the invention, which is arranged for carrying out a preferred embodiment of a method according to the invention.

### DETAILED DESCRIPTION OF THE INVENTION

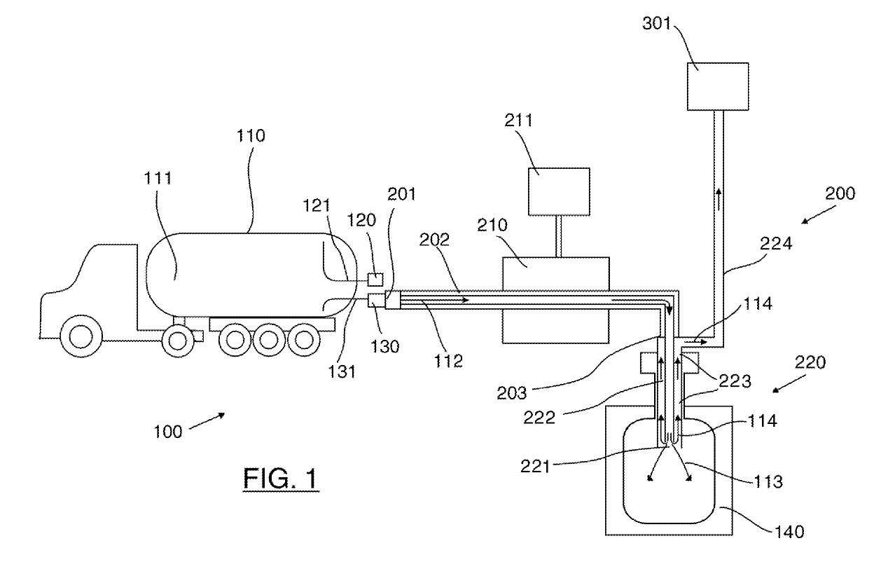

In FIG. 1, a helium filling station 100 is represented diagrammatically. Helium is supplied in a pressurized container 110, for example, by truck. The helium is fed from the pressurized container 110 processed and then fed into a second storage container or vessel 140, for example, into one or more Dewar containers 140. Alternatively, or additionally, the helium is used to cool down a cryostat and/or devices within a cryostat.

The helium is stored in a pressurized container 110 at a high pressure of 3.1 barg or 45 psig, for example. Thus, within the pressurized container 110, there is only supercritical helium 111.

For the removal of the helium from the pressurized container 110, a preferred design of the removal device 200 according to the invention is provided, which is arranged for carrying out a preferred embodiment of a method according to the invention.

The removal device 200 comprises a first connection 201, which is arranged so as to be connected to a removal connection of the pressurized container 110. Within the pressurized container 110, several removal lines 121, 131 can run, which are each connected to a removal connection 120 or 130. In the example represented, the first connection 201 of the removal device 200 is connected to the removal connection 130.

The first connection 201 of the removal device 200 is connected to a line 202. The line 202 is designed, for example, to be double-walled and vacuum super insulated. Moreover, the removal device 200 comprises an active cooling device 210. This cooling device can be designed, preferably, as a Stirling refrigerator, a Gifford-McMahon refrigerator or a pulse tube refrigerator. In this example, according to a particularly preferable design of the invention, the cooling device 210 is formed as a heat exchanger with a compressor 211. For example, by means of the heat exchanger 210, a cooling fluid can flow around the line 202, in order to cool the medium flowing through the line 202. Furthermore, downstream of the active cooling device 210, the removal device 200 comprises a Joule-Thomson cooler 220. Via a second connection 203, the removal device can be connected to the Dewar container 140.

When the removal device 200 is connected to the removal connection 130 of the pressurized container 110, in the context of the invention, supercritical and cryogenic helium 111 is removed from the pressurized container 110.

This removed supercritical helium 112 flows through the line 202 and through the heat exchanger 210, wherein it is in each case still pressurized, to the Joule-Thomson cooler 220.

By means of the heat exchanger 210, heat is removed from the removed helium 112, and the helium is cooled. In the Joule-Thomson cooler 220, the helium 112 removed is subjected to a Joule-Thomson expansion. As a result of this active and passive cooling, the removed helium is at least partially liquefied on a low-pressure side 221 of the Joule-Thomson cooler 220. This liquefied portion of the removed helium is stored as liquid helium 113 in the Dewar container 140.

Since, the entire amount of removed helium 112 is not liquefied by means of the Joule-Thomson cooler 220, cold gaseous helium 114 is also generated.

This cold gaseous helium 114 is removed through a gas discharge from the low-pressure side 221 of the Joule-Thomson cooler 220. In the process, the removed cold gaseous helium 114 is led along a high-pressure side 222 of the Joule-Thomson cooler 220, in order to further cool the removed helium 112 located therein, before it is subjected to the Joule-Thomson expansion.

The removed cold gaseous helium 114 can advantageously be both conveyed for both storage 140 and/or supplied via supply line 224 for further use 301. For completeness, both of these options are shown in FIG. 1. However, the invention covers embodiments in which the removed cold gaseous helium is only supplied to a container for storage; and embodiments in which the removed cold gaseous helium is only supplied for further use.

For example, the removed cold gaseous helium 114 can be supplied to a heat exchanger and then to a compressor of a helium gas filling installation 301 and/or to a helium gas storage tank 140. Alternatively, the further use 301 may involve supplying the to a cryostat in order to cool down the cryostat and/or cool down component devices within the cryostat

Due to the removal of supercritical/cryogenic helium 111, the pressure within the pressurized container 110 drops. As soon as this pressure has reached a value of 2.29 bara, for example, liquid helium can be removed directly from the container 110.

### LIST OF REFERENCE NUMERALS

100 Helium filling station
110 Pressurized container
111 Supercritical helium
112 Removed supercritical helium
113 Liquid helium
114 Cold gaseous helium
120 Removal connection
121 Removal line
130 Removal connection
131 Removal line
140 Dewar container
200 Removal device
201 First connection of the removal device
202 Line
203 Second connection of the removal device
210 Heat exchanger
211 Compressor of the heat exchanger
220 Joule-Thomson cooler
221 Low-pressure side of the Joule-Thomson cooler
222 High-pressure side of the Joule-Thomson cooler
223 Gas discharge
224 Supply line
301 Supply of removed cold gaseous helium for further use, for example Heat exchanger and compressor of a helium gas filling installation

1. A method for removing helium from a pressurized container (110), wherein supercritical helium (111) is removed from the pressurized container (110),
characterized in that
the removed supercritical helium (112) is actively cooled by means of a cooling device (210) and/or passively cooled by means of a Joule-Thomson expansion (220); and thereby at least partially forms liquid helium (113).

2. The method according to claim 1, wherein the supercritical helium (112) removed from the pressurized container is actively cooled by means of a heat exchanger (210) as cooling device.

3. The method according to claim 1, wherein the supercritical helium (112) removed from the pressurized container is actively cooled by means of one of: a Stirling refrigerator; a Gifford-McMahon refrigerator; and a pulse tube refrigerator as cooling device (210).

4. The method according to claim 1, wherein, by means of the Joule-Thomson expansion (220) of the removed supercritical helium (112), cold gaseous helium (114) is also generated in addition to the liquefied helium (113), and wherein the generated cold gaseous helium (114) is removed (223).

5. The method according to claim 4, wherein the removed cold gaseous helium (114) is used to cool the supercritical helium (112) removed from the pressurized container (110), at a high-pressure, upstream side (222) of the Joule-Thomson expansion (220).

6. The method according to claim 1, wherein the at least partially liquefied helium (113) is supplied to a second pressurized container or a Dewar container (140).

7. The method according to claim 1, wherein the at least partially liquefied helium (113) is used to cool down a cryostat and/or devices within a cryostat.

8. A removal device (200) for removing helium from a pressurized container (110), comprising:
a connection (201), which is arranged to be connected to a removal connection (130) of the pressurized container (110) for the removal of supercritical helium (111) from the pressurized container (110),
characterized in that the removal device (200) comprises:
an active cooling device (210) downstream of the connection (201) and/or
a Joule-Thomson cooler (220) downstream of the connection (201).

9. The removal device (200) according to claim 8, wherein the cooling device (210) is one of the following: a heat exchanger; a Stirling refrigerator; a Gifford-McMahon refrigerator; or a pulse tube refrigerator.

10. The removal device (200) according to any one of claim 8, further comprising a gas discharge (223) for removing cold gaseous helium (114) from a low-pressure side (221) of the Joule-Thomson cooler (220).

11. The removal device (200) according to any one of claims 8 to 10, further configured such that the cold gaseous helium (114) is conveyed to be used for further cooling purposes and/or other usage.

12. The removal device (200) according to any one of claims 8 to 11, wherein the connection (201) is connected to a line (202), and
wherein the active cooling device (210) is integrated in the line (202) and/or connected to said line at the end the line (202).

13. The removal device (200) according to any one of claims 8 to 12, further comprising a second connection (203) downstream of the cooling device (210) and/or the Joule-Thomson cooler (220), the second device being configured to be connected to a second pressurized container (140) and/or a supply line (224).

14. The removal device according to any of claims 8 to 13, wherein the second connection (203) is connected to a second pressurized container (140).

15. The removal device according to any of claims 8 to 14, wherein the second connection (203) is connected to a supply line (224) configured to convey the cold gaseous helium for further use.
